(19) United States
(12) Patent Application Publication
(10) Pub. No.: US 2016/0310852 A1
(43) Pub. Date: Oct. 27, 2016

(54) GAME RECORDING APPARATUS AND GAME RECORDING METHOD

(71) Applicant: ATEN International Co., Ltd., New Taipei City (TW)

(72) Inventors: Chun Chi Liao, New Taipei City (TW); Hao Jun Chen, New Taipei City (TW); Chia Chang Hsu, New Taipei City (TW)

(73) Assignee: ATEN International Co., Ltd., New Taipei City (TW)

(21) Appl. No.: 15/014,259

(22) Filed: Feb. 3, 2016

(30) Foreign Application Priority Data
Apr. 24, 2015 (TW) 104206338

(51) Int. Cl. A63F 13/86

(52) U.S. Cl. CPC A63F 13/86

(57) ABSTRACT

A game recording apparatus includes a video processing module, a video buffering module, an information converting module, a subtitle buffering module, and a video integrating module. The video processing module is coupled between a game console and video buffering module. The information converting module is coupled between a game controller and subtitle buffering module. The video processing module receives a video signal from game console and codes it, and coded video signal is stored in video buffering module. The information converting module receives an operation information from game controller and converts operation information into a subtitle information and saves it into subtitle buffering module. The video integrating module integrates coded video signal and subtitle information into a game video information with a specific video format. Therefore, requirements of time constraint and computing power can be reduced and operation load and cost of game recording apparatus can be lowered.

### BACKGROUND OF THE INVENTION

1. Field of the Invention

This invention relates to electronic game recording, and in particular, it relates to game recording apparatus and game recording method.

2. Description of Related Art

Typically, regardless of what types of game console is used (e.g., X-BOX, PS4, etc.), the game players often search for game playing strategies or tips from online or other sources to use as references when playing the games. In addition to articles in text form that discuss game strategies, there are game strategy videos in audio-visual form. Players who provide such game strategy videos typically capture images during the game play using a computer or video camera, share them with others in real time online, or store them as files and share them with others later.

Some game strategy videos can simultaneously display game operation information, for example, which keys on the game controller the player needs to press and the sequence of the key presses in order to make the actors in the game successfully overcome the challenges as seen in the game video. However, when making such game strategy videos using conventional technologies, as shown in FIG. 1, one first needs to convert game operation information corresponding to each frame of image F1 to F5 of the game video F into images D1 to D5, then synchronize and integrate the images D1 to D5 with the image frames F1 to F5 using a synchronization and integration module SM to generate the game video F′; then, the game video is encoded using the encoding module EC before output.

A drawback of the above conventional technology is that it increases the requirements on time constraint and computing power, which in turn increases the hardware requirements for the game recording device used to make the game strategy videos. The cost and computational load are high. Moreover, it cannot selectively turn on and off the game operation information.

### SUMMARY

Accordingly, the present invention is directed to a game recording apparatus and related method that substantially obviate one or more of the problems due to limitations and disadvantages of the related art.

An embodiment of the present invention provides a game recording device. In this embodiment, the game recording device is coupled to a game console and a game controller respectively. The game recording device includes a video processing module, a video buffering module, an information converting module, and a video integrating module. The video processing module is coupled between the game console and the video buffering module. The information converting module is coupled between the game controller and the subtitle buffering module. The video integrating module is coupled to the first video buffering module and the subtitle buffering module respectively. The video processing module receives a video signal from the game console and encodes the video signal, and temporarily stores it in the video buffering module. The information converting module receives operation information from the game controller and converts it to subtitle information, and temporarily stores it in the subtitle buffering module. The video integrating module integrates the coded video signal and the subtitle information to generate game video data having a specified video format.

In one embodiment, the video integrating module is further coupled to a video playing device, wherein the video integrating module outputs the game video data to the video playing device to be played.

In one embodiment, the video playing device receives a remote control command from a corresponding remote control device and selectively displays the subtitle information based on the remote control command when playing the game video data.

In one embodiment, the specified video format of the game video data is MP4, MPEG-2, MKV, TS, or DVB format.

In one embodiment, the game recording device further includes a hotkey determination module. The hotkey determination module is coupled to the game controller, for determining whether the operation information from the game controller includes a hotkey command. If it does, the game recording device executes a specified function corresponding to the hotkey command.

In one embodiment, the specified function is starting and ending of recording, calling a player interface menu, or editing the electronic program guide EPG.

In one embodiment, the game recording device further includes an electronic program guide generating module. The electronic program guide generating module is coupled to the video integrating module, for generating electronic program guide for the video integrating module, wherein the video integrating module selectively integrates the electronic program guide into the game video data.

In one embodiment, the electronic program guide contains information related to a game including a number of players and game time. The electronic program guide generating module obtains the electronic program guide from an external device or generates the electronic program guide based on input form a user.

Another embodiment of the present invention is another game recording device. In this embodiment, the game recording device is respectively coupled to a game console, a game controller and a video input device. The game recording device includes a first video processing module, a first video buffering module, a second video processing module, a second video buffering module, an information converting module, a subtitle buffering module, and a video integrating module. The first video processing module is coupled between the game console and the first video buffering module. The second video processing module is coupled between the video input device and the second video buffering module. The information converting module is coupled between the game controller and the subtitle buffering module. The video integrating module is coupled to the first video buffering module, the second video buffering module and the subtitle buffering module.

The first video processing module receives a first video signal from the game console and encodes the first video signal, and temporarily stores it in the first video buffering module. The second video processing module receives a second video signal from the video input device and encodes the second video signal, and temporarily stores it in the second video buffering module. The information converting module receives operation information from the game controller and converts it to subtitle information, and temporarily stores it in the subtitle buffering module. The video integrating module integrates the coded first video signal, the coded second video signal and the subtitle information to generate game video data having a specified video format.

In one embodiment, the second video processing module is further coupled to the information converting module. The information converting module receives the second video signal from the video input device and converts it to other subtitle information, and temporarily stores it in the subtitle buffering module. The video integrating module selectively integrates the other subtitle information into the game video data.

Another embodiment of the present invention is a game recording method. In this embodiment, the game recording method includes: (a) receiving a video signal outputted by a game console, encoding the video signal and temporarily storing the coded video signal; (b) receiving operation information from a game controller, converting the operation information into subtitle information and temporarily storing the subtitle information; and (c) integrating the coded video signal and the subtitle information to generate game video data having a specific video format, and outputting the game video data.

As compared to conventional technologies, the game recording device and method according to embodiments of the present invention have “parallel processing” and “channel multiplexing” characteristics. When making such game strategy videos, it is not necessary to convert the operation information corresponding to each image frame into images. Rather, only when the game operation has changes, the operation information is converted into synchronized subtitle information with time stamps; as to the game video, it is first encoded and then integrated with the synchronized subtitle information. As a result, the time constraint and computing power requirements are effectively reduced, significantly reducing the computational load of the game recording device and reducing cost.

The game recording device and method according to embodiments of the present invention have the following further advantages:

(1) It can directly use existing video formats to store all game video data, without requiring development of new video formats.

(2) It can directly use existing codex devices and playing formats to play the game video data, without requiring development of new codex devices and playing formats.

(3) The user can use existing playing format to selectively display or not display key-press information (subtitle information) and to switch between different video tracks based own needs, and can even simultaneously watch images of game play and images of the player's operation using the picture-in-picture display.

### BRIEF DESCRIPTION OF THE DRAWINGS

FIG. 1 illustrates a conventional process for making game strategy videos.

FIG. 2 is a functional block diagram showing a game recording device according to an embodiment of the present invention.

FIG. 3A illustrates a game image of the coded first video signal AV1′.

FIG. 3B illustrates a game player image of the coded second video signal AV2′.

FIG. 3C illustrates a subtitle SUB generated by converting the operation information OI.

FIG. 3D illustrates the game video data GD played by the video playing device 4, showing an image which combines the game image of coded first video signal AV1′ and the subtitle information SUB.

FIG. 3E illustrates an picture-in-picture played by the video playing device 4, showing a game image of the coded first video signal AV1′ and a game player image of the coded second video signal AV2′.

FIG. 4 is a flow chart showing a game recording method according to another embodiment of the present invention.

FIG. 5 illustrates a process of making a game strategy video according to an embodiment of the present invention.

### DETAILED DESCRIPTION OF PREFERRED EMBODIMENTS

An embodiment of the present invention provides a game recording device. In this embodiment, the game recording device is respectively coupled to the game console and the game controller. The game console and the game controller are not limited to any particular types or models.

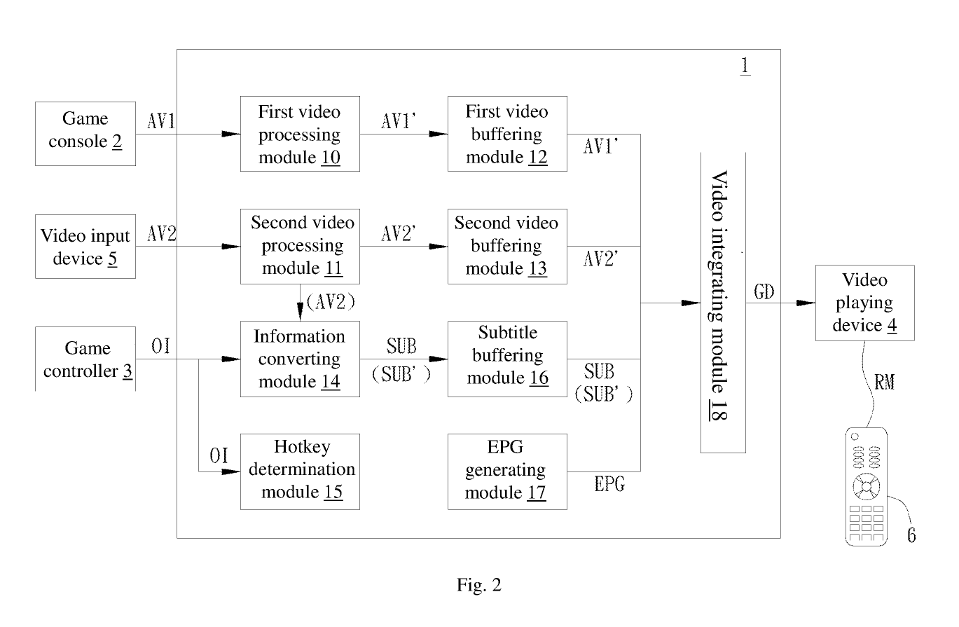

Refer to FIG. 2, which is a functional block diagram showing a game recording device according to this embodiment. As shown in FIG. 2, the game recording device 1 is respectively coupled to the game console 2, game controller 3, video playing device 4 and video input device 5. The video playing device 4 may be remotely controlled by the remote control signal RM transmitted by the remote control device 6, but is not limited to such.

In this embodiment, the game recording device 1 includes a first video processing module 10, a second video processing module 11, a first video buffering module 12, a second video buffering module 13, an information converting module 14, a hotkey determination module 15, a subtitle buffering module 16, an electronic program guide generating module 17 and a video integrating module 18.

The first video processing module 10 is coupled between the game console 2 and the first video buffering module 12; the second video processing module 11 is coupled between the video input device 5 and the second video buffering module 13, and is also coupled to the information converting module 14; the information converting module 14 is coupled between the game controller 3 and the subtitle buffering module 16; the hotkey determination module 15 is coupled to the game controller 3; the first video buffering module 12, the second video buffering module 13, the subtitle buffering module 16 and the electronic program guide generating module 17 are respectively coupled to the video integrating module 18; and the video integrating module 18 is coupled to the video playing device 4.

The “parallel processing” and “channel multiplexing” technologies of the game recording device 1 are described in detail now.

First, because the first video processing module 10 is coupled between the game console 2 and the first video buffering module 12, the first video processing module 10 and the first video buffering module 12 form a first channel coupled to the game console 2. In practice, the game console 2 may be, without limitation, commercially available X-Box, PS4 or other types or models of game consoles,

When the first video processing module 10 receives the first video signal AV1 output from the game console 2, the first video processing module 10 encodes the first video signal AV1, to generate coded first video signal AV1′. Then, the first video processing module 10 outputs the coded first video signal AV1′ to the first video buffering module 12 to be temporarily stored there.

Also, because the second video processing module 11 is coupled between the video input device 5 and the second video buffering module 13, the second video processing module 11 and the second video buffering module 13 form a second channel coupled to the video input device 5. In practice, the video input device 5 may be, without limitation, a video capture device (such as video recorder), for capturing a video of the player and the environment (such as the body movements of the player when playing a body movement-controlled game), to generate the second video signal AV2.

When the second video processing module 11 receives the second video signal AV2 output by the video input device 5, the second video processing module 11 encodes the second video signal AV2, to generate coded second video signal AV2′. Then the second video processing module 11 outputs the coded second video signal AV2′ to the second video buffering module 13 to be temporarily stored there.

Further, because the information converting module 14 is coupled between the game controller 3 and the subtitle buffering module 16, the information converting module 14 and subtitle buffering module 16 form a third channel coupled to the game controller 3. In practice, the game controller 3 may be, without limitation, a joystick, keyboard, or any other game controller that can control the game console 2.

When the information converting module 14 receives the operation information OI from the game controller 3, the information converting module 14 converts the operation information OI to subtitle information SUB and outputs the subtitle information SUB to the subtitle buffering module 16 to be temporarily stored there.

It should be noted that the operation information OI of the game controller 3 may include key presses and their sequence of the keys of the game controller 3, which are converted by the information converting module 14 to the subtitle information SUB which contains corresponding text or symbols representing the key presses. For example, assuming that the operation information OI of the game controller 3 includes a key press sequence which is “A”, “↑”, “B”, “↓”, “Δ”, and “∘” on the game controller 3, the information converting module 14 can convert the key press sequence to subtitle information SUB containing the text and symbols “A↑B↓Δ∘”. Moreover, the subtitle information SUB may have a time stamp, but is not limited to such.

Thereafter, when the video integrating module 18 receives the coded first video signal AV1′, the coded second video signal AV2′ and the subtitle information SUB respectively temporarily stored in the first video buffering module 12, the second video buffering module 13 and the subtitle buffering module 16, the video integrating module 18 integrates the coded first video signal AV1′, the coded second video signal AV2′ and the subtitle information SUB into a game video data GD that has a specific video format. Then, the video integrating module 18 outputs the game video data GD to the video playing device 4 to be played.

In practice, the specific video format of the game video data GD may be, without limitation, MP4, MPEG-2, MKV, TS, DVB, or any other video format.

In another embodiment, in addition to the above-described coded first video signal AV1′, coded second video signal AV2′ and subtitle information SUB, the video integrating module 18 further receives the electronic program guide EPG generated by the electronic program guide generating module 17, and selectively integrates the electronic program guide EPG into the game video data GD. In practice, the electronic program guide EPG may include information related to the game such as the number of players, game time, etc. The electronic program guide generating module 17 may obtain the electronic program guide EPG from an external source, or the player may input the electronic program guide EPG themselves, and is not limited to the above.

Moreover, the hotkey determination module 15 also receives the operation information OI from the game controller 3. When the hotkey determination module 15 receives the operation information OI, the hotkey determination module 15 determines whether the operation information OI from the game controller 3 includes a specific hotkey command.

If the determination of the hotkey determination module 15 is affirmative, i.e., the player inputted the specific hotkey through the game controller 3, the game recording device 1 will execute a corresponding specific function based on the specific hotkey. If the determination of the hotkey determination module 15 is negative, i.e., the player did not input the specific hotkey through the game controller 3, the game recording device 1 will take no action.

In practice, the specific function corresponding to the specific hotkey may be starting and ending of recording, calling the player interface menu, editing the electronic program guide EPG, or any other suitable functions, without limitation.

Further, the player can also transmit remote control commands RM to the video playing device 4 using the remote control device 6 corresponding to the video playing device 4, to control the operation of the video playing device 4, such as, without limitation: to display (or not display) the subtitle information SUB while playing the game video data GD; to simultaneously display the coded first video signal AV1′ and the coded second video signal AV2′ using picture-in-picture; etc.

In another embodiment, the second video processing module 11 is further coupled to the information converting module 14, such that the information converting module 14 receives the second video signal AV2 from the video input device 5. Then, the information converting module 14 converts the second video signal AV2 into another subtitle information SUB′ and sends it to the subtitle buffering module 16, so that the video integrating module 18 can integrate the other subtitle information SUB′ into the game video data GD.

For example, assume that the second video signal AV2 from the video input device 5 includes the body movements of the player when playing a body movement-controlled game, which are “up”, “down”, “left” and “right” in that order. The information converting module 14 detects these movements in the second video signal AV2 using image recognition, and converts them to another subtitle information SUB′ represented by symbols “↑↓← →”. Further, the body movements in the second video signal can be converted to subtitle information represented by simple graphics; for example, if the body movement is raising the right hand, then the subtitle information can show a simple graphic of a human figure raising the right hand.

An actual operation scenario of the game recording device 1 is illustrated below with reference to the figures.

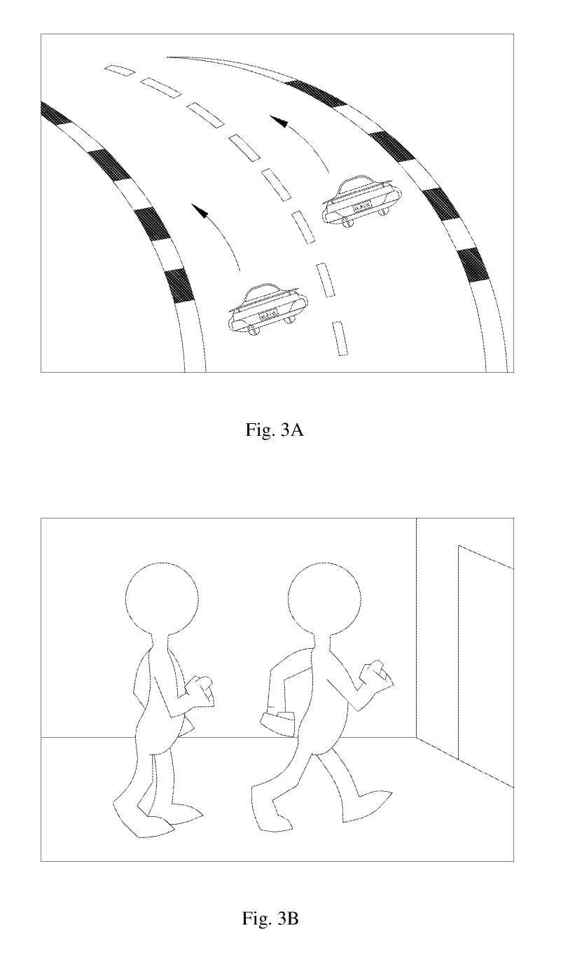

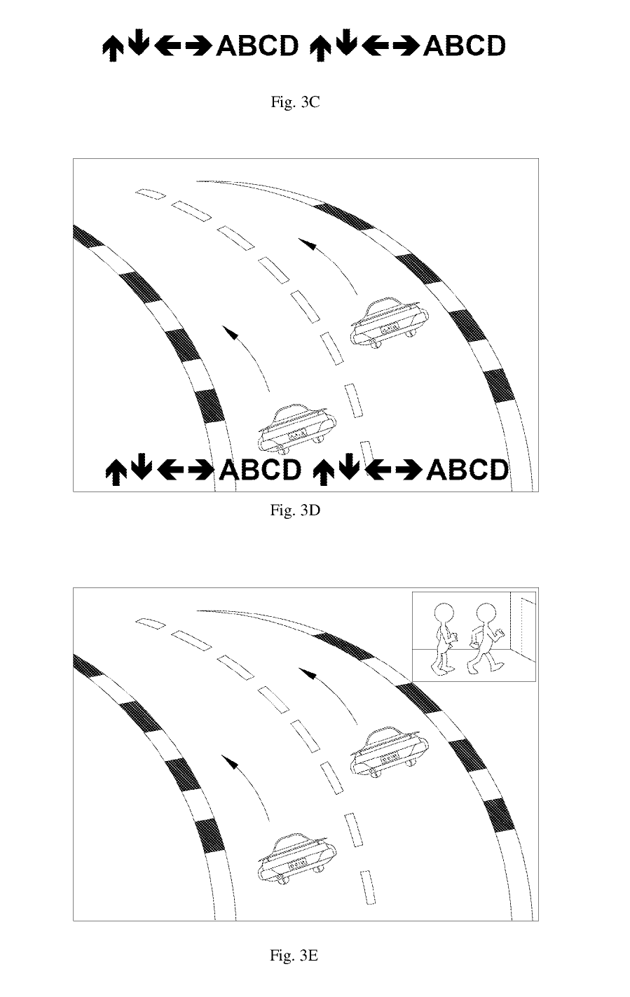

Refer to FIGS. 3A to 3E: FIG. 3A illustrates a game image in the coded first video signal AV1′; FIG. 3B illustrates a game player image in the coded second video signal AV2′; FIG. 3C illustrates a subtitle SUB generated by converting the operation information OI; FIG. 3D illustrates the game video data GD played by the video playing device 4, showing the game image in the coded first video signal AV1′ simultaneously with the subtitle information SUB′; and FIG. 3E illustrates an picture-in-picture played by the video playing device 4, showing the a game image in the coded first video signal AV1′ and the game player image in the coded second video signal AV2′.

It should be noted that when the video playing device 4 plays the game video data GD, because the game video data GD includes the coded first video signal AV1′, the coded second video signal AV2′ and the subtitle information SUB, the user can use the remote control device 6 corresponding to the video playing device 4 to transmit remote control signal RM to the video playing device 4, to control the video playing device 4 to play the game image in the coded first video signal AV1′ of the game video data GD and simultaneously display the subtitle information SUB (as sown in FIG. 3D), or control the video playing device 4 to simultaneously display the fame image in the coded first video signal AV1′ and the game player image in the coded second video signal AV2′ and turn off the subtitle information SUB so that it is not displayed (see FIG. 3E).

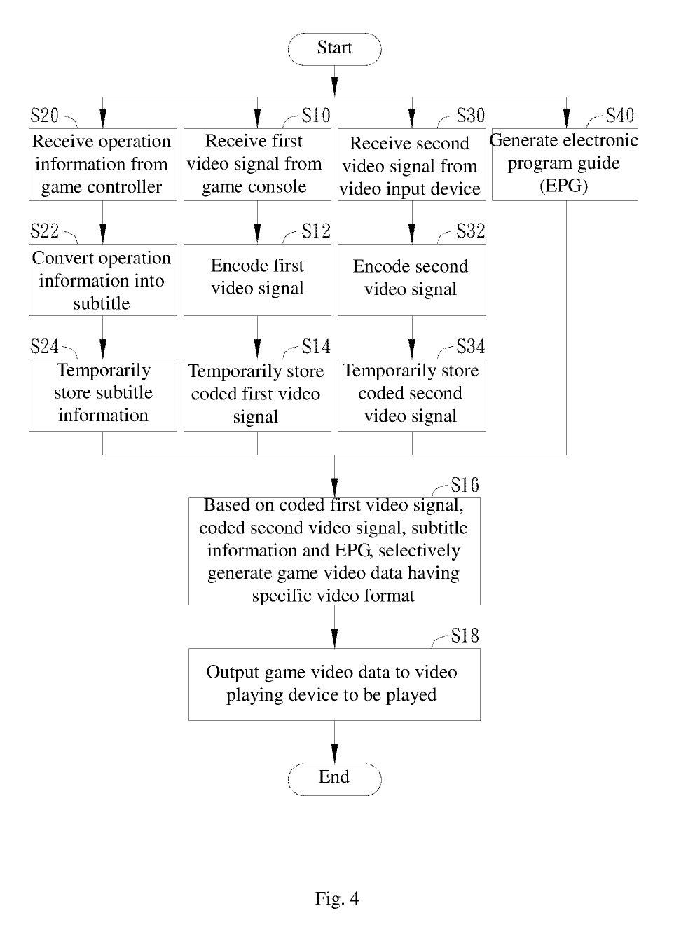

Another embodiment of the present invention is a game recording process. Refer to FIG. 4, which is a flow chart showing a game recording method according to another embodiment of the present invention. In this embodiment, the process executes step S10: receiving the first video signal outputted by the game console; step S20: receiving operation information from the game controller; step S30: receiving the second video signal outputted from the video input device; and step S40: generating an electronic program guide. It should be noted that the sequence of executing the above steps S10, S20, S30 and S40 is not limited to any specific sequence; in fact, the game recording process may concurrently execute the above steps S10, S20, S30 and S40.

After executing step S10, the game recording process sequentially executes steps S12 and S14, to encode the first video signal and temporarily store the coded first video signal.

After executing step S20, the game recording process sequentially executes steps S22 and S24, to convert the operation information into subtitle information and temporarily store the subtitle information.

After executing step S30, the game recording process sequentially executes steps S32 and S34, to encode the second video signal and temporarily store the coded second video signal.

After executing steps S14, S24, S34 and S40, the game recording process executes step S16: based on the coded first video signal, coded second video signal, subtitle information and electronic program guide, selectively generating game video data having a specific video format. Then, the game recording process executes step S18: outputting the game video data to the video playing device to be played.

In actual operation, when the video playing device receives a remote control command from a corresponding remote control device, the game recording method can control the video playing device based on the remote control command, to selectively display the subtitle information when playing the game video, or to selectively display the coded first video signal and the coded second video signal using the picture-in-picture format.

Further, the game recording method can further determine whether the operation information from the game controller includes a specific hotkey command. If it does, the game recording method executes a specific function corresponding to the hotkey command. If it does not, the recording method takes no action.

It should be noted that, in addition to the above coded first video signal, coded second video signal, subtitle information and electronic program guide, the game recording method can also convert the second video signal from the video input device to another subtitle information and integrate it into the game video data.

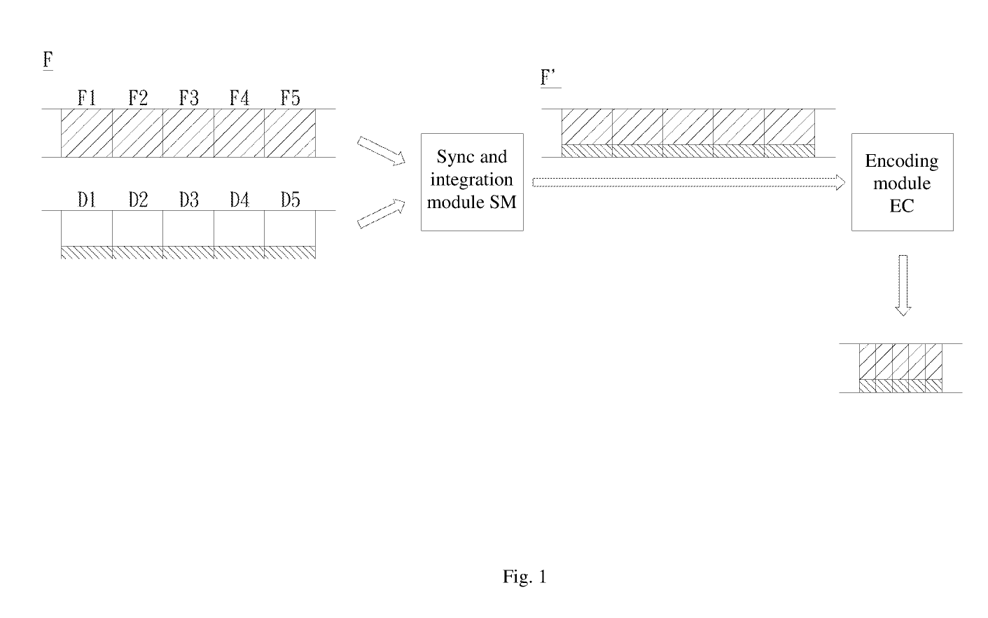

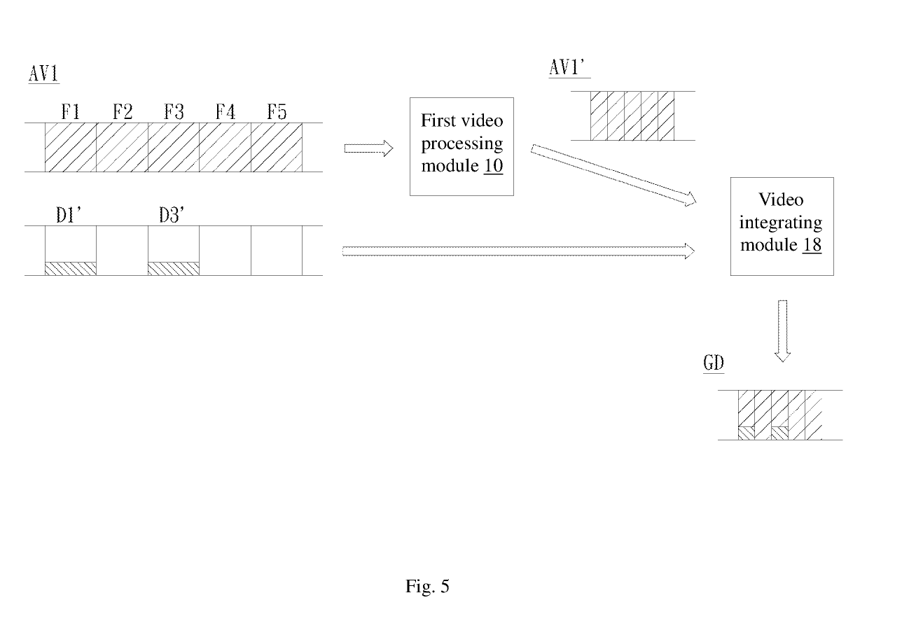

As compared to conventional technologies, the game recording device and method according to embodiments of the present invention have “parallel processing” and “channel multiplexing” characteristics. When making game strategy videos, it is not necessary to convert the operation information corresponding to each image frame F1 to F5 of the game video F into images D1 to D5 as in the conventional technology shown in FIG. 1. Rather, as shown in FIG. 5, only when the game operation has changes (for example, the game operation changes at time points corresponding to image frames F1 and F3 of the first video signal AV1), the information converting module 14 converts the operation information OI into synchronized subtitle information D1′ and D3′; as to the first video signal AV1, it is first encoded by the first video processing module 10 into the coded first video signal AV1′, which is then integrated by the video integrating module 18 with the synchronized subtitle information D1′ and D3′ to output the game video data GD. In embodiments of the present invention, because it is not necessary to convert the operation information corresponding to each image frame into subtitle information, and because the video signal is first encoded and then integrated with the synchronized subtitle information, the time constraint and computing power requirements are effectively reduced, significantly reducing the computational load of the game recording device and reducing cost.

The game recording device and method according to embodiments of the present invention have the following further advantages:

(1) It can directly use existing video formats to store all game video data, without requiring development of new video formats.

(2) It can directly use existing codex and playing formats to play the game video data, without requiring development of new codex and playing formats.

(3) The user can use existing playing format to selectively display or not display key-press information (subtitle information) and to switch between different video tracks based own needs, and can even simultaneously watch images of game play and images of the player's operation using the picture-in-picture display.

It will be apparent to those skilled in the art that various modification and variations can be made in the game recording device and method of the present invention without departing from the spirit or scope of the invention. Thus, it is intended that the present invention cover modifications and variations that come within the scope of the appended claims and their equivalents.

What is claimed is:

1. A game recording device, coupled to a game console and a game controller respectively, the game recording device comprising:
a first video processing module, coupled to the game console, for receiving a first video signal outputted from the game console and encoding the first video signal;
a first video buffering module, coupled to the first video processing module, for temporarily storing the coded first video signal;
an information converting module, coupled to the game controller, for receiving operation information from the game controller and converting it to subtitle information;
a subtitle buffering module, coupled to the information converting module, for temporarily storing the subtitle information; and
a video integrating module, respectively coupled to the first video buffering module and the subtitle buffering module, for integrating the coded first video signal and the subtitle information to generate game video data having a specified video format.

2. The game recording device of claim 1, wherein the video integrating module is further coupled to a video playing device, wherein the video integrating module outputs the game video data to the video playing device to be played.

3. The game recording device of claim 2, wherein the video playing device receives a remote control command from a corresponding remote control device and selectively displays the subtitle information based on the remote control command when playing the game video data.

4. The game recording device of claim 1, wherein the specified video format of the game video data is MP4, MPEG-2, MKV, TS, or DVB format.

5. The game recording device of claim 1, further comprising:
a hotkey determination module, coupled to the game controller, for determining whether the operation information from the game controller includes a hotkey command, and if it does, the game recording device executes a specified function corresponding to the hotkey command.

6. The game recording device of claim 5, wherein the specified function is starting and ending of recording, calling a player interface menu, or editing the electronic program guide EPG.

7. The game recording device of claim 1, further comprising:
an electronic program guide generating module, coupled to the video integrating module, for generating electronic program guide for the video integrating module, wherein the video integrating module selectively integrates the electronic program guide into the game video data.

8. The game recording device of claim 7, wherein the electronic program guide contains information related to a game including a number of players and game time, and wherein the electronic program guide generating module obtains the electronic program guide from an external device or generates the electronic program guide based on input from a user.

9. A game recording device, respectively coupled to a game console, a game controller and a video input device, the game recording device comprising:
a first video processing module, coupled to the game console, for receiving a first video signal outputted from the game console and encoding the first video signal;
a first video buffering module, coupled to the first video processing module, for temporarily storing the coded first video signal;
a second video processing module, coupled to the video input device, for receiving a second video signal outputted from the video input device and encoding the second video signal;
a second video buffering module, coupled to the second video processing module, for temporarily storing the coded second video signal;
an information converting module, coupled to the game controller, for receiving operation information from the game controller and converting it to subtitle information;
a subtitle buffering module, coupled to the information converting module, for temporarily storing the subtitle information; and
a video integrating module, respectively coupled to the first video buffering module, the second video buffering module and the subtitle buffering module, for integrating the coded first video signal, the coded second video signal and the subtitle information to generate game video data having a specified video format.

10. The game recording device of claim 9, wherein the video integrating module is further coupled to a video playing device, wherein the video integrating module outputs the game video data to the video playing device to be played.

11. The game recording device of claim 10, wherein the video playing device receives a remote control command from a corresponding remote control device, and selectively displays the subtitle information and/or selectively displays the coded first video signal and the coded second video signal using a picture-in-picture form based on the remote control command when playing the game video data.

12. The game recording device of claim 9, wherein the video input device is a video capture device for capturing video of a player to generate the second video signal.

13. The game recording device of claim 9, wherein the second video processing module is further coupled to the information converting module,
wherein the information converting module receives the second video signal from the video input device and converts it to other subtitle information,
wherein the subtitle buffering module temporarily stores the other subtitle information, and
wherein the video integrating module selectively integrates the other subtitle information into the game video data.

14. A game recording method, comprising:
(a) receiving a first video signal outputted by a game console, encoding the first video signal and temporarily storing the coded first video signal;
(b) receiving operation information from a game controller, converting the operation information into subtitle information and temporarily storing the subtitle information; and
(c) integrating the coded first video signal and the subtitle information to generate game video data having a specific video format, and outputting the game video data.

15. The game recording method of claim 14, further comprising:
outputting the game video data to a video playing device to be played;
wherein the video playing device receives a remote control command from a corresponding remote control device and selectively displays the subtitle information based on the remote control command when playing the game video data.

16. The game recording method of claim 14, further comprising:
receiving a second video signal outputted by a video input device, encoding the second video signal and temporarily storing the coded second video signal;
selectively integrating the coded second video signal into the game video data.

17. The game recording method of claim 16, further comprising:
outputting the game video data to a video playing device to be played;
wherein the video playing device receives a remote control command from a corresponding remote control device, and selectively displays the subtitle information and/or selectively displays the coded first video signal and the coded second video signal using a picture-in-picture form based on the remote control command when playing the game video data.

18. The game recording method of claim 16, further comprising:
receiving a second video signal outputted by a video input device, converting the second video signal into other subtitle information and temporarily storing the other subtitle information;
selectively integrating the other subtitle information into the game video data.

19. The game recording method of claim 14, further comprising:
determining whether the operation information from the game controller includes a hotkey command; and
if it does, executing a specified function corresponding to the hotkey command.
